(19) United States
(12) Patent Application Publication
(10) Pub. No.: US 2023/0138011 A1
(43) Pub. Date: May 4, 2023

(54) Dual Band Radio for Railway Communications Applications

(71) Applicant: Meteorcomm LLC, Renton, WA (US)

(72) Inventor: Arun Naidu, Woodinville, WA (US)

(21) Appl. No.: 17/976,200

(22) Filed: Oct. 28, 2022

Related U.S. Application Data
(60) Provisional application No. 63/273,094, filed on Oct. 28, 2021.

(51) Int. Cl. H04B 1/00; H04B 1/40

(52) U.S. Cl. CPC H04B 1/0064; H04B 1/40

(57) ABSTRACT

Improvements for radios for communications between an end of train unit to a head of train that allows for simultaneous reception of messages on any one of three RF link types, for example, Association of American Railroads (AAR) S-9152 RF links in the 450 MHz band, ITCR (Interoperable Train Control Radio) links in the 220 MHz band, and RF links in the 450 MHz band using a higher-order modulation and coding scheme than provided by S-9152.

### RELATED APPLICATION

This application claims the benefit of U.S. Provisional Application 63/273,094, filed Oct. 28, 2021, which is incorporated herein in its entirety by reference for all purposes.

### FIELD OF INVENTION

The invention generally relates to radio communication systems for applications supporting railroads and, more particularly, wireless messaging between an end of train and a head of train.

### BACKGROUND

Modern railway operations, particularly those of class I freight railroads with long trains, require various electronic devices for monitoring, signaling, and controlling trains and devices located on trains. One such device is an “end of train” (EOT) unit or device attached to the rear of the last car of a train. Because the final car in a train may change at any point in a trip, the EOT unit needs to be relatively easily and quickly removed by train personnel and attached to the new final car.

An EOT unit is, therefore, typically an integrated device with a structure and enclosure that facilitates its attachment and removal from the train car, protects the equipment, and discourages unauthorized access to the equipment. Initially, EOT units were relatively simple devices with a signal light for the end of the train. However, EOT units have evolved to handle more functions and are now required by regulation on trains that go over 30 miles per hour and operate on heavy grades. EOT units now include additional equipment or components that monitor or interoperate with one or more subsystems on the train and perform signaling and communication functions.

For example, one of the functions of modern EOT units is to monitor the train's braking system pressure at the last car and report it or a loss of pressure to a head of train (HOT) unit or device located in, for example, the lead locomotive. If there is adequate pressure at the train's last car, the cars in front of it will have adequate pressure. Another function of an EOT is to provide emergency braking control to the rear section of a train. EOT units are thus capable of receiving an emergency braking signal from a HOT device. EOTs may also, for example, include GPS or other components for detecting geolocation to identify the end of train, train movement, and train speed.

A HOT unit will usually be capable of communicating over the local area network with other systems in a train's locomotive. HOT units are typically capable of communicating with computers and other circuits used to control the operation of the train and its various subsystems.

The HOT unit and EOT unit typically use radios to communicate wirelessly. Each unit will have a radio capable of transmitting to and receiving a wireless signal from the radio in the other unit. Wireless messages between EOT and HOT in North America are sent over a radio frequency (RF) link in the 450 MHz band and are expected to conform to the S-9152 standard in the Manual of Standards and Recommended Practices published by the Association of American Railroads (AAR).

### SUMMARY

The invention pertains to improvements to radio frequency communications for railway applications and can offer additional advantages when used for radio frequency communications with an end of train (EOT) unit.

The 450 MHz band used for communication with an EOT unit does not provide a sufficiently robust communication channel between an EOT unit and the HOT for RF links conforming to the S-9152 standard when a train is very long. In certain situations, the RF link can have insufficient throughput or bandwidth to carry the amount of data that must be reliably transported for such communications.

Disclosed below are representative examples of a radio useful for an EOT unit and, optionally, a HOT unit that supports three RF link types. In the representative examples, the radio supports legacy S-9152 RF links in the 450 MHz band, ITCR (Interoperable Train Control Radio) links in the 220 MHz band, and RF links in the 450 MHz band that uses a higher-order modulation and coding scheme than provided by S-9152. Each radio integrates the capability of supporting all three link types into one radio that allows for simultaneous reception of a message on any of the three RF link types.

ITCR networks using the 220 MHz band are currently deployed in the United States and elsewhere for use by railroads to transport positive train control (PTC) messages between base stations and train locomotives using RF links specified by the ITCR standard. At the lower frequencies used by ITCR, RF signals exhibit better propagation and less susceptibility to noise. ITCR radio frequency links also allow for higher-order modulation, which allows for higher throughput. However, 220 MHz radios cannot be deployed immediately and ubiquitously for EOT to HOT communications, nor do all railroads operate 220 MHz ITCR networks.

Deploying a new radio in a HOT or EOT unit that supports three RF link types for transporting of EOT/HOT messages enable the unit to interoperate with legacy radios that support only S-9152 RF links, units that have radios that support ITCR RF links, and, in the future, units that use an enhanced RF link type for the 450 MHz band, with higher-order modulation and coding. With the ability for the radio to receive a message on any of the three RF link types, an EOT with the radio can receive emergency messages from a HOT unit on any one or all of the three links simultaneously.

### BRIEF DESCRIPTION OF THE DRAWINGS

FIG. 1a is a schematic diagram of a first, nonlimiting, representative example of a dual-band radio for EOT communication.

FIG. 1B a schematic diagram of a variation of the first, nonlimiting, representative example of a dual-band radio for EOT communication of FIG. 1a.

FIG. 2 is a schematic diagram of a second, nonlimiting, representative example of a dual-band radio for EOT communication.

FIG. 3 is a schematic diagram of a third, nonlimiting, representative example of a dual-band radio for EOT communication.

FIG. 4 is a schematic diagram of a fourth, nonlimiting, representative example of a dual-band radio for EOT communication.

FIG. 5 is a schematic diagram of a fifth, nonlimiting, representative example of a dual-band radio for EOT communication.

FIG. 6 is a schematic diagram of a sixth, nonlimiting, representative example of a dual-band radio for EOT communication.

### DETAILED DESCRIPTION

In the following description, like numbers refer to like elements.

The examples of radios described below are digital radios implemented as a software defined radio (SDR). An SDR implements some conventional components of a radio, such as modulators, demodulators, filters, mixers, etc., using software running on a processer or other programmable hardware circuit, examples of which a digital signal processor (DSP), field-programmable gate arrays (FPGA), and general-purpose processors. In addition to hardware for executing the processes, an SDR will also have additional hardware, such as memory for storage, analog amplifiers and filters for its RF stage, analog to digital (ADC) and digital to analog (DAC) converters, interfaces, and power supplies. An SDR provides several possible advantages, including multi-channel capability and the ability to adapt to different channel conditions.

For example, a digital radio receiver functions or acts like a conventional radio but processes a digitized version of an RF or IF frequency division multiplexed (FDM) signal for an entire band. After the received RF or IF frequency signal is processed by a radio frequency stage, the digital receiver samples the FDM signal using an analog-to-digital converter to generate a discrete, time-invariant signal representing a continuous sequence of samples. The digitized FDM signal is then demodulated and decoded according to the modulation and coding scheme being used by the RF link using a processor that will, in effect, down-convert and filter the sampled FDM signal into separate baseband digital signals corresponding to different predefined channels within the band for detection of data that was transmitted. Similarly, a digital baseband signal (usually as in-phase and quadrature-phase signals) generated according to a particular modulation and coding scheme is used to modulate the phase and/or amplitude of a carrier frequency.

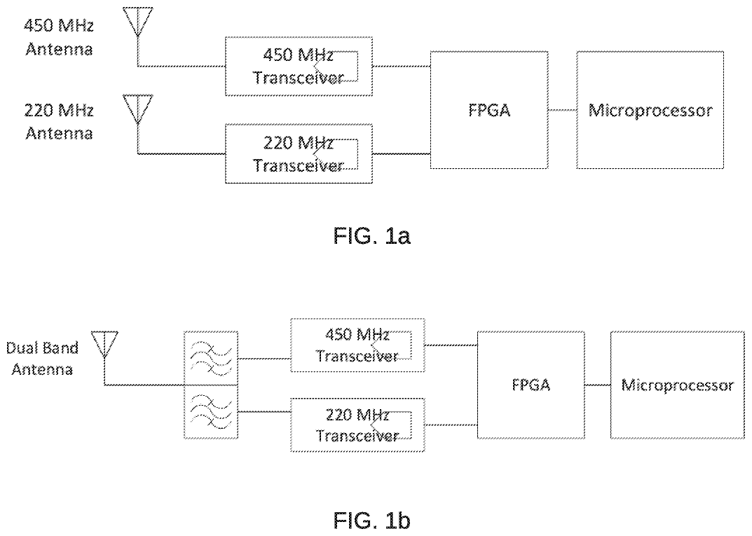

FIGS. 1a, 1b, 2, 3, 4, 5, and 6 illustrate schematically representative examples of embodiments for a radio capable of supporting three RF link types for use by an end of train (EOT) or a head of train (HOT) unit with separate RF stages for signals in a first RF band and signals in a second RF band. In these examples, the first RF band is the 450 MHz RF band, and the second RF band is the 220 MHz band.

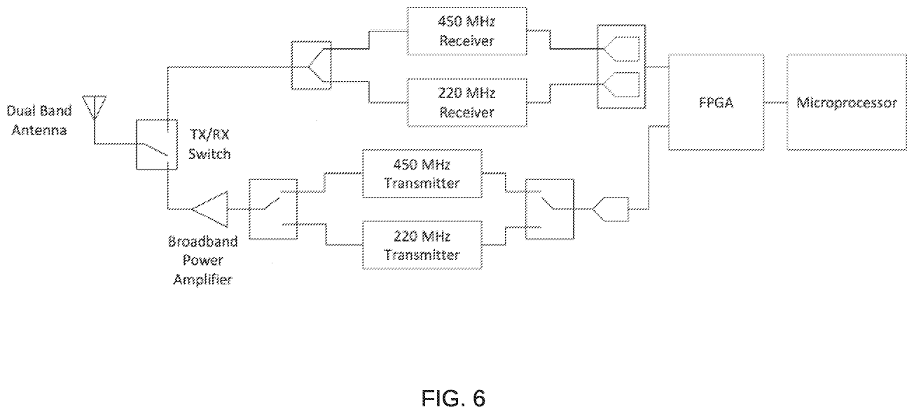

Radios 100, 200, 300, 400, 500, and 600 shown in FIGS. 1a and 1b to 6, each have two RF stages, one for the first RF band and one for the second RF band. Each RF stage has a receiving path for receiving signals in the corresponding RF band and a transmission path for transmitting a signal in the corresponding RF band. In the examples of radios 100, 200, 300, 400, and 500, the first RF stage includes a first band RF transceiver 102, and a second RF stage includes a second band transceiver 104. Each transceiver has both a receiver and a transmitter integrated as a single unit, with separate receiving and transmission paths within the unit. Radio 600, of FIG. 6, uses separate receivers and transmitters. Two RF stage receiving paths are implemented by a first RF band receiver 616 and second RF band receiver 618, and two RF stage transmission paths provided by a first RF band transmitter 604 and second RF band transmitter 606. Unlike the transceivers used in radios 100 to 500, separating the transmitter and receiver can allow different configurations that permit certain benefits or advantages, and possibly disadvantages. Each of these radios is an example of a radio with at least two, independent RF stage paths corresponding to each of the RF bands, allowing the radio to be capable of independent RF stage operation in each frequency band. Therefore, the transmission and receiving operations in each RF band do not interfere with either other.

For each of these examples, a shared baseband processor 106 coordinates the operation of the RF stages. The baseband processor is programmed to handle frequency conversion to and from baseband for both 220 MHz signals and 450 MHz band signals and channel filtering. It is also programmed to handle modulation/demodulation for baseband signals with legacy S-9152 coding and modulation schemes for the 450 MHz band, enhanced modulation and coding schemes for the 450 MHz band that might be adopted in the future for communications with an EOT unit, and modulation and coding schemes specified by the ITCR standard for RF links in the 220 MHz band. In this example, the shared baseband processor 106 is implemented by a field-programmable gate array (FPGA) and is labeled as such in the figures. However, as explained above, the shared baseband processor could be implemented using a digital signal processor or another type of processor. References to FPGA should be understood to include alternative implementations such as DSPs or other processors capable of being programmed as described unless explicitly stated otherwise.

Applications software for the EOT application running on microprocessor 120 processes data streams produced by the demodulation and decoding of the baseband processor 106. Although not shown, the microprocessor may be connected to nonvolatile storage in the form of EEPROM to store configuration data; memory for storing application and operating system code, such as flash memory; a working memory, such as RAM; an Ethernet network interface, and a USB data interface. It communicates with the FPGA over, for example, a serial peripheral interface (SPI).

Referring now to FIGS. 1a and 1b, each RF transceiver 102 and 104 has a converter (represented by converters 108 and 110, respectively) for converting analog to digital signals (for received signals) and digital to analog signals (for transmission). The analog to digital conversion samples a RF or IF analog signal from the receiving path in the RF stage of the transceiver to generate a digital signal that is communicated to the shared baseband processor 106. The digital to analog conversion process converts a digital baseband signal to an analog signal for the transmission path in the RF stage of the transceiver.

In the example of FIG. 1a, the first band RF transceiver is adapted to transmit and receive frequency division multiplexed (FDM) signals in the 450 MHz band used by S-9152 using a dedicated antenna 112. The second bandwidth transceiver is adapted to transmit and receive radio frequency signals in the 220 MHz band used by ITCR using antenna 114.

In FIG. 1B, the transceivers 102 and 104 share a dual-band antenna 116 capable of transmitting and receiving signals in the 220 MHZ and 450 MHz bands. Transceivers 102 and 104 are coupled to antenna 116 through a duplexer filter circuit represented by bandpass filters 118 and 119 to allow the RF stages for each transceiver 102 and 104 to share the antenna. This circuit is controlled by, for example, the baseband processor 106. The duplexer filter circuit allows the paths of the two transceivers to be combined in the RF stage to share a single dual-band antenna. However, adding a duplexer filter circuit will introduce signal loss and increase the cost and size of the radio.

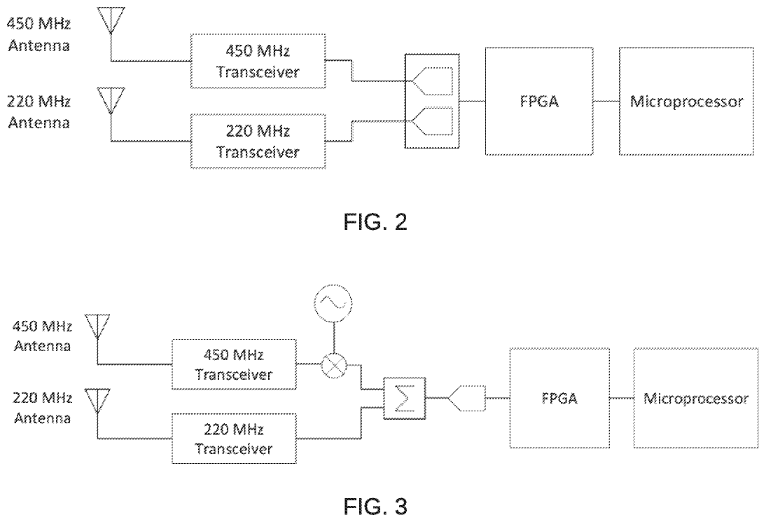

Referring now to FIG. 2, radio 200 is similar to radio 100 except that it utilizes a dual ADC/DAC 202 that receives the output of the RF stage of transceivers 102 and 104, thus avoiding separate ADC/DACs for each transceiver as shown in FIGS. 1a and 1b.

In FIG. 3, radio 300 is another representative and nonlimiting example of a radio configured for supporting three RF link types in which the received signal of one or both the transceivers are mixed to produce outputs for both transceivers that are adjacent to one another in frequency before digitization. In this example, the received signal output from transceiver 102 is mixed by mixer 306 with a signal from oscillator 307 to produce a signal that is frequency adjacent with the received output signal from transceiver 104. These signals are then combined using combiner 308 before being digitized by analog to digital converter (ADC) 302. The combining can be done at the radio frequency or an intermediate frequency, depending on the sampling frequency and the use of under-sampling or oversampling. This arrangement allows both bands to be processed simultaneously with a single ADC. The two signals can be separated again in the baseband processor 106 using digital filtering.

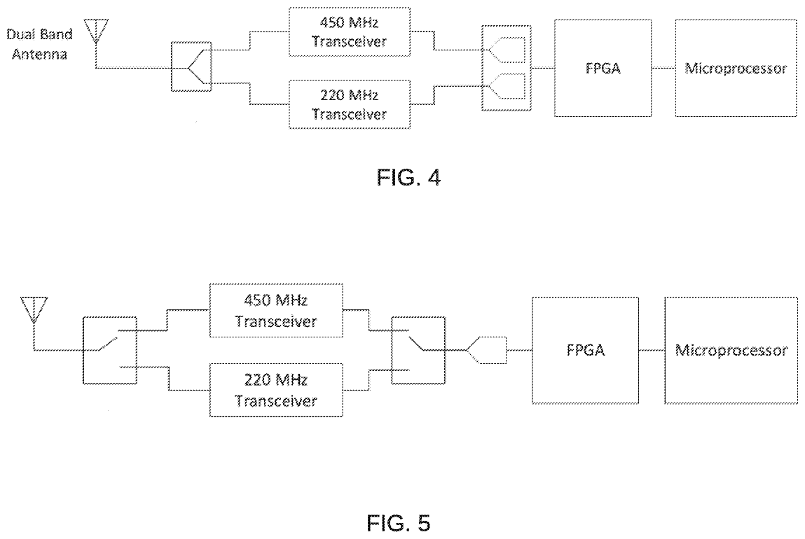

In FIG. 4, radio 400 resistively splits the received signal from dual-band antenna 116 using splitter/combiner 402 and tunes one circuit to 450 MHz for first band transceiver 102 and the other circuit to 220 MHz for second transceiver 104. Similarly, the splitter/combiner 402 combines the transmitted signal before amplification. This configuration allows for the use of a single dual-band antenna but at the cost of a 3 dB loss when the signal from the antenna is split, thus reducing the sensitivity of the receiver circuit in each of the transceivers 102 and 104. A dual ADC/DAC 404 coupled with the first band transceiver 102 and the second band transceiver 104 converts between analog and digital signals for processing by baseband processor 106.

Radio 500 in FIG. 5 is an example of a radio that supports three RF links in which the receiver and/or transmitter are switched between 450 MHz and 220 MHz operations. The switching is represented by switches 502 and 504, which are controlled by baseband processor 106, to connect in an alternating fashion either first band transceiver 102 or second band transceiver 104 in series with the dual-band antenna 116 and ADC 506. This arrangement allows for a single dual-band antenna and a single ADC/DAC, and thus less circuitry and lower cost. However, it achieves these benefits at the expense of creating a “deaf” receiver during the portion of time the transceiver is operating on the opposite band.

Radio 600 in FIG. 6 is a representative example of an embodiment of a radio for railway applications that is configured for and is capable of simultaneously supporting three RF link types. This embodiment allows the sharing of a broadband RF power amplifier 602 by the first band transmitter 604 and the second band transmitter 606 by switching transmit paths through the radio. Switch 608 connects the first RF band transmitter 604 or the second RF band transmitter 606 to the broadband power amplifier 602. Switch 610 connects the output of the digital to analog converter DAC 612, which converts the digital baseband signal generated by the baseband processor 106 into an analog signal for modulating the carrier signal of the transmitter to which it is connected by switch 610. A transmit/receive switch 614 connects the dual-band antenna 116 to the broadband power amplifier for transmission mode to broadcast the transmitted signal. The transmit/receive switch 614 connects the dual-band antenna 116 to the first RF band receiver 616 and second RF band receiver 618 through a splitter 620, which splits the signal between the two receivers. In this example, the output signals from the first band and second band receivers are digitized using a dual ADC 622. However, the outputs of the first and second band receivers could be, for example, digitized as shown in the other examples of radios described above.

The preceding description is of exemplary and preferred embodiments. The invention is defined by the appended claims and is not limited to the described embodiments. The embodiments are, unless otherwise noted, nonlimiting examples. Alterations and modifications to the disclosed embodiments may be made without departing from the invention. Furthermore, unless expressly defined otherwise, the meaning of terms used in this specification that are not explicitly defined are intended to have their ordinary and customary meaning to those in the art and not be limited by any of the characteristics or features of the example or embodiment that is being described using the term.

What is claimed is:

1. A radio for railway communication application comprising:
a first RF stage with a first receiving path for receiving signals in a first RF band and a first transmission path for transmitting signals in the first RF band;
a second RF stage with a second receiving path for receiving signals in the second RF band and a second transmission path for transmitting signals in the second RF band, the first and second RF stage paths operating independently of each other;
one or more analog to digital converters coupled with the first and second RF stage paths for converting analog signals received by the first and second RF stages to a digital signal;
one or more digital to analog converters coupled with the transmitting path of the first RF stage and the second RF stage for converting digital signals to analog signals; and
a baseband processor configured to:
receive and demodulate received signals received digitized by the one or more analog to digital converters according to any one of least two different modulation and coding schemes; and
generate a digital baseband signal for transmission according to any of the two or more modulation and coding schemes for conversion by one or more digital to analog converts to an analog signal and select the transmission path of the first RF Stage path or of the second RF Stage path for transmission of the analog baseband signal.

2. The radio of claim 1, wherein the first RF stage comprises a first transceiver and the second RF stage comprises a second transceiver.

3. The radio of claim 2, wherein the first transceiver is coupled to a first antenna and the second transceiver is coupled to a second antenna.

4. The radio of claim 3, wherein the first and second transceivers are coupled to a shared antenna through one or more of a bandpass filter, a splitter, and a switch.

5. The radio of claim 1, wherein the first receiving path is comprised of a first receiver, the second receiving path is comprised of a second receiver, the first transmission path is comprised of a first transmitter, and the second transmission path is comprised of a second transmitter.

6. The radio of claim 5, wherein the first transmitter and the second transmitter each have an input coupled to the one or more digital to analog converters through a switch that connects the input of either the first or the second transmitter to the one or more digital to analog converters.

7. The radio of claim 5, wherein the first transmitter and the second transmitter each have an output coupled with an antenna through a switch that selects either the output of either of the first or the second transmitter to the antenna.

8. The radio of claim 1, wherein any one of the two or more different modulation and coding schemes comprises three or more different modulation and coding schemes.

9. The radio of claim 8, wherein the two of the three or more different modulation and coding schemes are for signals transmitted or received in the first RF band.

10. The radio of claim 1, wherein a first one the two or more different modulation and coding schemes is specified by AAR S-9152, and the other is an ITCR modulation and coding scheme.

11. The radio of claim 1, wherein the first RF band is a 450 MHz band and the second RF band is a 220 MHz band.

12. The radio of claim 1, wherein the baseband processor is comprised of at least one field-programmable gate array (FPGA) that has been configured by programming.

13. The radio of claim 1, wherein the radio is configured for an end of train (EOT) unit for transporting EOT messages.

14. A radio for railway communication application comprising:
a first RF stage with a first receiving path for receiving signals in a first RF band and a first transmission path for transmitting signals in the first RF band;
a second RF stage with a second receiving path for receiving signals in the second RF band and a second transmission path for transmitting signals in the second RF band, the first and second RF stage paths operating independently of each other;
one or more analog to digital converters coupled with the first and second RF stage paths for converting analog signals received by the first and second RF stages to a digital signal;
one or more digital to analog converters coupled with the transmitting path of the first RF stage and the second RF stage for converting digital signals to analog signals; and
a baseband processor configured to:
receive and demodulate received signals received digitized by the one or more analog to digital converters according to any one of least two different modulation and coding schemes; and
generate a digital baseband signal for transmission according to any of the two or more modulation and coding schemes for conversion by one or more digital to analog converts to an analog signal and select the transmission path of the first RF Stage path or of the second RF Stage path for transmission of the analog baseband signal;
wherein,
any one of the two or more different modulation and coding schemes comprises three or more different modulation and coding schemes, and a first one the two or more different modulation and coding schemes is specified by AAR S-9152, and the other is an ITCR modulation and coding scheme.

15. The radio of claim 14, wherein the two of the three or more different modulation and coding schemes are for signals transmitted or received in the first RF band.

16. The radio of claim 14, wherein the baseband processor is comprised of at least one field-programmable gate array (FPGA) that has been configured by programming.

17. The radio of claim 14, wherein the radio is configured for an end of train (EOT) unit for transporting EOT messages.
